(19) United States
(12) Patent Application Publication
(10) Pub. No.: US 2011/0317424 A1
(43) Pub. Date: Dec. 29, 2011

(54) LIGHTING DEVICE AND USE THEREOF

(75) Inventors: Gernot Eberle, Konstanz (DE); Benjamin Ingolf Stubbe, Daellikon (CH); Brice Parmentier, Neuhausen (CH)

(73) Assignee: 3A Technology & Management Ltd., Neuhausen am Rheinfall (CH)

(21) Appl. No.: 13/255,699

(22) PCT Filed: Mar. 11, 2010
(86) PCT No.: PCT/EP10/01521

§ 371 Date: Sep. 9, 2011

(30) Foreign Application Priority Data
Mar. 17, 2009 (DE) 10 2009 013 219.8

(51) Int. Cl. F21V 21/00

(52) U.S. Cl. 362/249.02

(57) ABSTRACT

The invention relates to a lighting device, comprising a multi-layer carrier plate with a large number of through-openings, in each of which an LED is accommodated. According to the invention, it is provided that the through-holes, accommodating the LEDs have a circular cross-sectional face. Furthermore, the invention relates to the use of a carrier plate of this type.

The invention relates to a lighting device, comprising a multi-layer carrier plate with a large number of through-openings, in each of which an LED (light diode, luminescent diode, light-emitting diode) is accommodated. Furthermore, the invention relates to the use of a carrier plate of this type.

With DE 20 2008 008 181 U1 the Applicant is applying for protection for a carrier plate for LEDs, wherein a plurality of rows of receiving openings for the LEDs are provided in the carrier plate and the LEDs are, at least partially, connected to one another by lines. The receiving openings for the LEDs are, in this case, continuously contoured in a rectangular manner. As emerges from the utility model, the use of multi-layer composite plates as a carrier plate had already been thought of, in particular the plates marketed by the Applicant under the trade marks Alucobond® and Alucore®, which, in each case, have metal cover sheets made of aluminium. In practice, it has been found that signs of delamination of individual layers of the composite plates may occur when these plates are used as a carrier plate for LEDs. In particular for aesthetic reasons and with regard to ensuring a long service life of a corresponding lighting device, this is to be avoided.

The invention is therefore based on the object of disclosing a lighting device, comprising a multi-layer composite carrier plate, in which signs of delamination in individual layers are avoided. Furthermore, the object is to disclose a use for a lighting device of this type.

This object is achieved in a generic lighting device in that the through-openings accommodating the LEDs have a circular cross-sectional face. With regard to the use, the object is achieved by the use of the lighting device as a façade panel and/or a display board.

Advantageous configurations of the invention are given in the sub-claims. All combinations of at least two features disclosed in the description, the claims and/or the figures come within the framework of the invention.

For a long time, the cause of the delamination of individual layers of a multi-layer carrier plate was unclear. The invention has recognised that the signs of delamination in known lighting devices are surprisingly to be attributed to the rectangular contour of the through-openings to accommodate the LEDs. The invention has furthermore recognised that the delamination effects can surprisingly be avoided by implementing through-openings with circular cross-sectional faces. The circular cross-section is preferably provided, in this case, at each axial position of the through-openings, i.e. the inner periphery of the through-openings preferably has the shape of the internal shell of a cylinder. However, implementing circularly contoured through-openings entails the problem that the previously conventional, rectangularly contoured LEDs cannot be inserted, or only with difficulty. With regard to implementing circularly contoured through-openings in multi-layer carrier plates, there are different possibilities. Thus, the through-openings can be produced, for example, by machining, preferably by drilling. It is also possible to cut the circularly contoured through-openings, for example by means of a laser or water jet, or to punch them out of the carrier plate.

In a development of the invention it is advantageously provided that at least some of the LEDs, preferably arranged in a plurality of rows, are connected to one another by means of at least one common electrical conductor, i.e. not all the LEDs are contacted individually by two conductors.

It is particularly advantageous here if some of the LEDs, preferably at least one row of LEDs, are already combined to form a preassembled lighting module, which is preferably distinguished by the fact that a plurality of LEDs is already contacted together by at least one joint electrical connection line. The use of a preassembled lighting module of this type facilitates the assembly of the proposed lighting device considerably. There are different possibilities with regard to the specific configuration of the preassembled lighting module. In the simplest, preferred embodiment, the preassembled lighting module is configured as a chain of lighting, in the manner used for Christmas tree decoration. An embodiment can also be implemented in which the LEDs of the preassembled lighting module are already arranged at a fixed spacing with respect to one another on a frame or on a carrier rail in order to reduce the assembly steps for assembling the preassembled lighting module on the carrier plate still further, as the entire lighting module can be assembled easily by rearward insertion.

An embodiment of the lighting device is quite particularly expedient, in which the LEDs do not rest flush over their entire peripheral extent on the inner cylindrical periphery of the through-openings, but in which a peripheral gap is formed between a respective LED and the inner periphery of the associated through-opening, it being still further preferred if the peripheral gap extends over at least 50%, preferably at least 70%, more preferably at least 80%, of the peripheral extent of the respective LED, i.e. is only partially interrupted by radial spacers which are still to be described. The implementation of a peripheral gap of this type allows moisture to pass through, in particular water, whereby the accumulation of moisture in a region above the LED is advantageously avoided.

An embodiment of the lighting device is particularly expedient, in which each LED has a plastics material housing, which is supported by means of integral spacers on the inner periphery of the associated through-opening. In this case, the spacers are preferably arranged distributed uniformly over the periphery, the sum of the peripheral extents of the spacers preferably being (substantially) smaller than the peripheral extent of the remaining peripheral gap.

It is particularly expedient if the LED housing is formed in two parts, in particular in the manner of a shell housing, a front shell of the housing still more preferably being formed from a transparent plastics material in order to allow the light radiation generated to pass through.

The LED housing quite particularly preferably has a circular base contour, so the housing can be uniformly spaced apart from the inner periphery of the through-opening, it preferably being possible to arrange the housing contour concentrically with respect to the inner periphery of the associated through-opening by means of the spacers. In this case, the spacers project over the circular housing base contour outwardly in the radial direction in order to be able to be supported on the inner periphery of the through-opening.

In order to ensure an optimal hold of the LEDs in the through-openings of the composite carrier plate, it is advantageously provided in a development of the invention that the LEDs are fastened by latching means to the carrier plate, the latching means preferably being an integral component of the LEDs, preferably of the LED housings. The latching means may, for example, comprise a latching nose, which locks onto the carrier plate, preferably in that, as will be described below, the at least one latching nose engages in a, preferably comparatively soft, intermediate layer of the carrier plate.

An embodiment of the lighting device is particularly expedient, in which the latching means for fixing the LEDs on the carrier plate are arranged on the integral spacers of the LED housing, the spacers substantially having a radial support function and the latching means being given an axial securing function.

As already described above, an embodiment is particularly preferred in which the latching means are arranged engaging radially in a layer arranged below the cover layer of the carrier plate, in particular an intermediate layer, preferably made of plastics material. In an embodiment of this type, engagement behind the front cover layer of the carrier plate is advantageously avoided, which has a positive effect, in particular, on the visual appearance of the carrier plate front side, as the LEDs, the latching means here, do not project up to this front side.

With regard to implementing a simple contacting possibility for the electrical contacting of the LEDs, it is preferred to provide the LEDs, in particular the LED housings, with a lateral contact connection, in each case, preferably for receiving a plug contact.

In a development of the invention, it is advantageously provided that a plurality of through-openings, preferably all the through-openings of a row of through-openings are connected to one another by means of at least one cable duct, it being possible to form the cable duct, for example, as a channel (groove-shaped, i.e. open on one side) on the carrier plate rear side and/or in an intermediate layer, which is closed by cover plates, of the carrier plate formed as a composite plate.

With regard to the specific configuration of the composite carrier plate, there are different possibilities. An embodiment is particularly preferred, in which at least the front side, in other words a front cover layer, is formed from metal, preferably from light metal or a light metal alloy, in particular from aluminium or an aluminium alloy, it being still further preferred if two cover layers accommodating at least one intermediate layer in the manner of a sandwich are configured in this manner.

At least one layer of the at least two-layer, preferably three-layer, carrier plate is preferably formed from plastics material, preferably polyethylene (PE). Composite plates of this type are marketed by the Applicant under the trade mark Alucobond® plate. The plastics material layer, in particular the PE layer, is preferably connected by lamination or casting to the at least one metallic cover layer.

In addition or alternatively to providing a plastics material intermediate layer, an embodiment can be implemented, in which the composite carrier plate has an intermediate layer formed as a honeycomb structure, preferably made of metal, preferably of light metal or a light metal alloy, in particular of aluminium or an aluminium alloy. Aluminium composite plates of this type are marketed by the Applicant under the trade mark Alucore® plates.

The invention also relates to the use of a lighting device formed as described above as a façade panel and/or as a display board. In the case of use of the lighting device as a display board, it is preferred if individual LEDs or groups of LEDs can be activated separately in order to be able to show different, in particular moving, images.

Further advantages, features and details of the invention emerge from the following description of preferred embodiments and with the aid of the drawings, in which:

FIG. 1 shows a front view of a lighting device, comprising a composite carrier plate which is provided with through-openings and in which a large number of through-openings are each provided with an LED held therein,

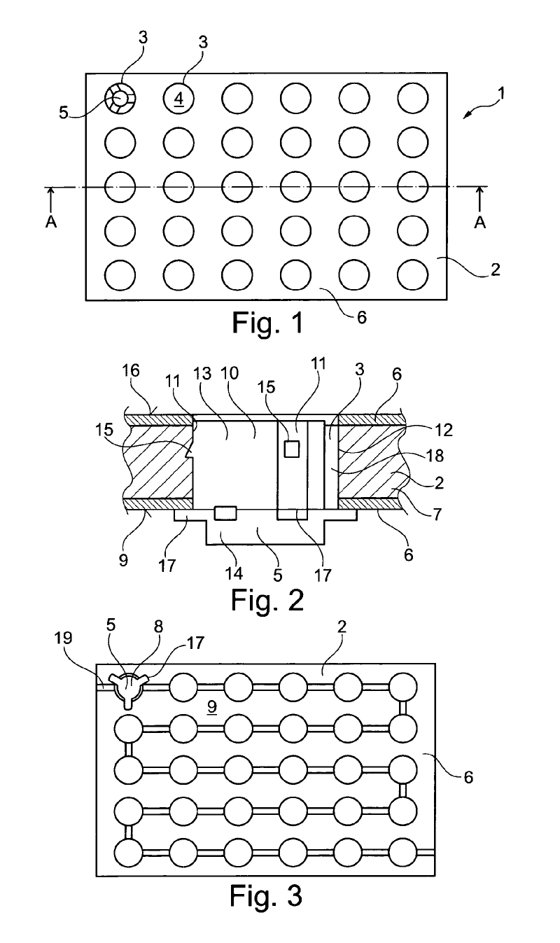

FIG. 2 shows a detail of the lighting device according to FIG. 1 along the section line A-A in a sectional view,

FIG. 3 shows a rear view of the lighting device according to FIGS. 1 and 2,

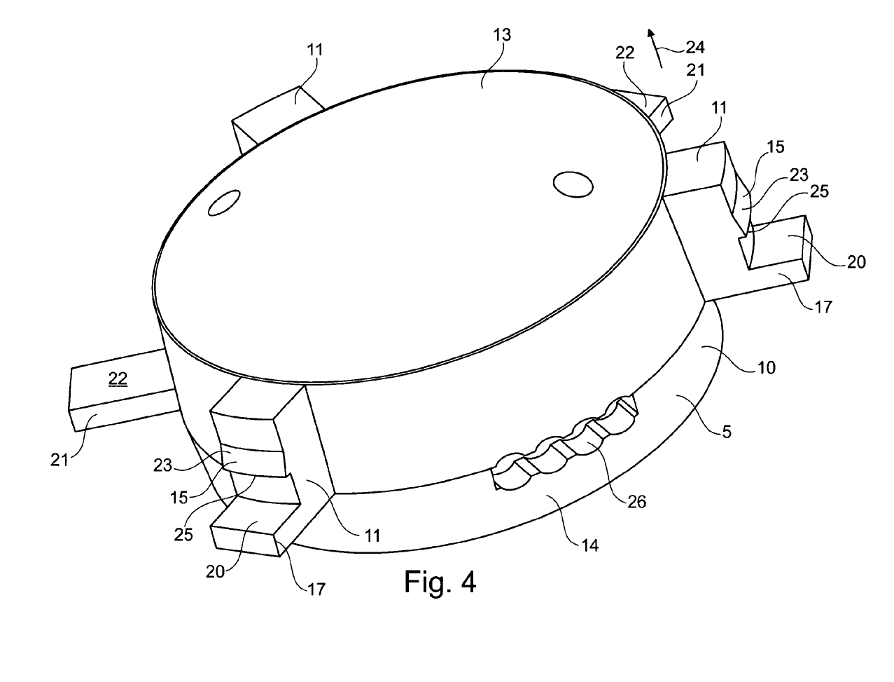

FIG. 4 shows a perspective view of a preferred embodiment of an LED for accommodation in a through-opening of a composite carrier plate to form a lighting device,

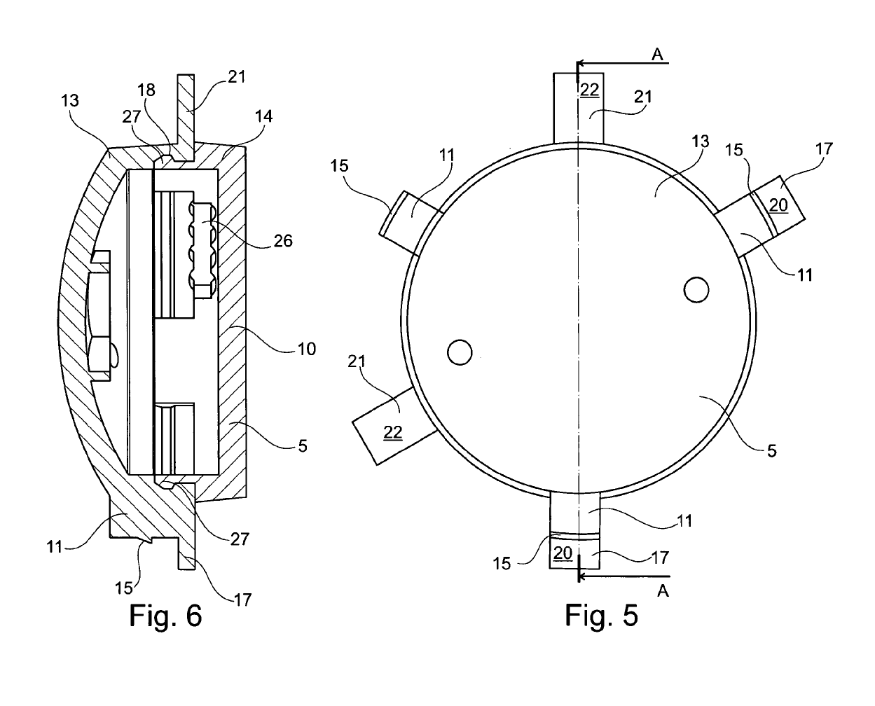

FIG. 5 shows a front view of the LED according to FIG. 4, and

FIG. 6 shows a sectional view of the LED according to FIG. 5 along the section line A-A.

The same elements and elements with the same function are designated by the same reference numerals in the figures.

FIG. 1 shows a lighting device 1 in a front view, for example as a façade panel and/or a display device. This comprises a carrier plate 2 configured as a composite plate, which, in the embodiment shown, has two cover layers made of an aluminium alloy and a plastics material intermediate layer arranged in between, made of PE here (cf. FIG. 2).

A large number of through-openings 3 which are arranged in rows, extending perpendicular to the surface extent of the carrier plate 2, are introduced into the carrier plate 2.

All the through-openings 3 have a circularly contoured cross-sectional face 4. As emerges from FIG. 1, the circular cross-sectional face 4 is not only implemented locally, but axially continuously.

In total, the carrier plate 2 has a rectangular peripheral contour—but can alternatively be implemented in any desired contour configuration, for example U-shaped or turned.

An LED 5 (light emitting diode) is arranged in each through-opening 3, an LED 5 only being drawn in the through-opening 3 located at the top left in the plane of the drawing for reasons of clarity. All the LEDs 5 of the lighting device 1 are connected to one another by means of electric connecting cables, not shown.

FIG. 2 shows a sectional view of a detail of the lighting device 1 along the section line A-A. The composite plate-like structure of the multi-layer carrier plate 2 can be seen. This comprises two identical metallic cover layers 6, which accommodate between them, in a sandwich-like manner, an intermediate layer 7 which is made of polyethylene.

A through-opening 3 with an inner cylindrical peripheral face can be seen by way of example. Accommodated in the through-opening 3 is an LED 5, which is inserted from a rear side 9 of the carrier plate 2 into the through-opening 3.

The LED 5 has a housing 10 made of plastics material, which is provided with three spacers 11 arranged uniformly distributed in the peripheral direction, which have the object of supporting the housing 10 in the radial direction on the inner periphery 12 of the through-opening 3.

The housing 10 is configured as a shell housing and comprises a transparent front part 13 (front shell) formed as an injection-moulded part and a rear, non-transparent cover 14 (rear shell), also formed as an injection-moulded part. The front part 13 and cover 14 are latched together.

Apart from the spacers 11, the housing 10 comprises latching means 15 which are formed, in the embodiment shown, as latching noses provided on the spacers 11, the latching noses being locked into the polyethylene intermediate layer 7 and not engaging behind a front side 16 remote from the rear side 9 and parallel thereto. As a result, it only becomes possible to implement the embodiment shown where the LED 5 does not project over the front side 16 of the carrier plate 2.

For axial securing, the housing 10 of the LED is provided with axial stops 17, with which the LED 5, more precisely the housing 10 of the LED 5, is supported on the rearward edge of the through-opening 3 on the rear side 9 of the carrier plate 2.

As emerges from FIG. 2—apart from the contact region of the spacers 11—produced radially between the housing 10 of the LED 5 and the inner periphery 12 of the through-opening 3 is a peripheral gap 18, through which moisture, in particular rain water, can flow.

For reasons of clarity, FIG. 2 does not show the groove-like cable ducts 19 which are on the rear side of the carrier plate 2, which connect the adjacent through-openings 3 to one another in order to be able to connect the individual LEDs 5 to one another electrically by means of electrical cables.

A possible arrangement of groove-like cable ducts 19 of this type emerges from FIG. 3. The cable ducts 19 in this case preferably pass through the rear cover layer 6 perpendicular to the surface extent of the carrier plate 2 into the polyethylene intermediate layer 7. According to an alternative embodiment, not shown, the cable ducts 19 on the two surface sides of the carrier plate 2 are concealed by the cover layers 6, in other words formed completely within the cover layers 6.

For reasons of clarity, FIG. 3 schematically shows the arrangement of only one single LED 5 from the rear side. It can be seen that the LED 5 is supported by means of the axial stops 17 on the rear side 9 of the carrier plate 2.

FIG. 4 shows a preferred embodiment of an LED 5 for use in a through-opening 3 in a carrier plate 2 according to FIGS. 1 to 3. The two-part housing 10 which is formed as a shell housing with its rear cover 14 and the transparent front part 13 can be seen.

Provided on the housing 10, more precisely on the front part 13, are integral spacers 11 arranged distributed uniformly over the periphery, which project over a circular base contour of the housing 10 in the radial direction. It emerges from FIG. 4 that the spacers 11 make up the smallest part of the peripheral extent of the housing 10, so a peripheral gap extending in the peripheral direction and divided into three can be implemented between the LED 5, more precisely the housing 10, and the inner periphery of a through-opening.

Formed in one piece with the spacers 11 is, in each case, an axial stop 17, which projects over the actual spacer 11 in the radial direction and has a support face 20 which is parallel to the carrier plate 2 for support on the rear side of the carrier plate 2. In total, an L-shape of the combination of spacer 11 and axial stop 17 is produced. In addition to the spacer/axial stop combinations 11, 17, two axial stops 21, that are separate from this are provided, which in each case also form a support face 22 for support on the carrier plate rear side. The support faces 22 are located in the same plane as the support faces 20 of the axial stops 17.

Latching means 15 which are formed as latching noses are located approximately half way along the axial extent of the (radial) spacers 11. These latching means in each case comprise a stop bevel 23 widening counter to the insertion direction 24 in the radial direction, the latching means 15 formed as latching noses being terminated by a rear engagement portion 25 in the axial direction.

The LEDs 5, more precisely the housing 10, can lock radially with the latching means 15 in the intermediate layer 7 shown in FIG. 2.

A contact opening 26 can also be inferred from FIG. 4 and is used to accommodate a plug contact, not shown, for the electrical contracting of the LED 5.

FIG. 5 shows the LED 5 according to FIG. 4 in a front view. The front part 13 which is formed as a plastics material injection-moulded part and the spacers 11 which are formed thereon with integral axial stops 17 can be seen. The spacer 11 which is located at the top left in the plane of the drawing has no axial supporting function, but merely has, like the other two spacers 11, lateral latching means 15. Apart from the above-described axial stops 17, two further axial stops 21 are provided, which have a flat support face 22 extending parallel to the carrier plate 2.

It emerges from FIG. 5 that the spacers 11 with latching means 15 are arranged offset with respect to one another uniformly in the peripheral direction, in other words by 120°, in each case. The axial stops 21 are in each case located centrally between two spacers 11 in the peripheral direction.

FIG. 6 shows a sectional view through the housing 10 of the LED 5 along the sectional line A-A according to FIG. 5. It can be seen that the lid 14 is latched to the front part 13. For this purpose, an axially extending, annular latching tongue 27, which can be radially sprung apart and can be formed, for example, by a surrounding peripheral wall of the cover 14, engages from radially inwardly to radially outwardly in a corresponding annular latching recess 8 of the front part 13, the latching recess 8 being formed by a peripheral, inner annular groove.

FIG. 6 shows the spacers 11 with integral latching means 15 and axial stops 17, and the radial extensions being used exclusively as an axial stop 21.

1. A lighting device, comprising a multi-layer carrier plate with a large number of through-openings, in each of which an LED is accommodated, wherein the through-openings accommodating the LEDs have a circular cross-sectional face.

2. A lighting device according to claim 1, wherein at least some of the LEDs are connected by a common electrical conductor.

3. A lighting device according to claim 2, wherein at least some of the LEDs are combined to form a preassembled lighting module, in which the LEDs are connected to one another by at least one electrical conductor.

4. A lighting device according to claim 1 wherein a peripheral gap, through which moisture, can flow away, is formed between the respective inner periphery of the through-openings and the associated LED.

5. A lighting device according to claim 1 wherein the LEDs each have one housing, which is supported by means of integral spacers on the inner periphery of the associated through-opening.

6. A lighting device according to claim 5 wherein the spacers are arranged radially projecting over a circular housing base contour.

7. A lighting device according to claim 5, wherein the LEDs are fixed by latching means to the carrier plate.

8. A lighting device according to claim 7, wherein the latching means are arranged on the integral spacers.

9. A lighting device according to claim 7, wherein the latching means are arranged engaging radially in a layer, arranged below a cover layer of the carrier plate.

10. A lighting device according to claim 1 wherein the LEDs have a lateral contact connection for electrical contacting.

11. A lighting device according to claim 1 wherein at least one cable duct connecting a plurality of the through-openings to one another is formed in the carrier plate rear side and/or an intermediate layer.

12. A lighting device according to claim 1 wherein at least one layer of the multi-layer carrier plate is formed from metal.

13. A lighting device according to claim 1 wherein at least one layer of the multi-layer carrier plate is formed from a plastics material.

14. A lighting device according to claim 1 wherein at least one layer of the multi-layer carrier plate is formed as a honeycomb support structure.

15. A method comprising using a lighting device according to claim 1 as a façade panel and/or as a display board.

16. A lighting device according to claim 2, wherein at least some of the LEDs are combined to form a preassembled lighting module, in which the LEDs are connected to one another in the manner of a chain of lights.

17. A lighting device according to claim 5, wherein the housing is two-part and at least partially transparent.

18. A lighting device according to claim 5, wherein the housing is made of a plastics material.

19. A lighting device according to claim 7, wherein the latching means is integral.

20. A lighting device according to claim 1, wherein at least one intermediate layer of the multi-layer carrier plate is formed from PE.

21. A lighting device according to claim 1, wherein at least one intermediate layer of the multi-layer carrier plate is formed as a honeycomb support structure made of a light metal or light metal alloy.

22. A lighting device according to claim 1, wherein the front cover layer of the multi-layer carrier plate is formed from a light metal or light metal alloy.
